(19) United States
(12) Patent Application Publication
(10) Pub. No.: US 2015/0227920 A1
(43) Pub. Date: Aug. 13, 2015

(54) MANAGEMENT OF IDENTITIES IN A TRANSACTION INFRASTRUCTURE

(71) Applicant: MasterCard International Incorporated, Purchase, NY (US)

(72) Inventors: Mohammed Sadiq, Dubai (AE); Carlos Edgar Cornejo, Old Greenwich, CT (US)

(21) Appl. No.: 14/618,395

(22) Filed: Feb. 10, 2015

(30) Foreign Application Priority Data
Feb. 10, 2014 (GB) 1402236.2

(51) Int. Cl. G06Q 20/34; G06Q 20/20; G06Q 20/10; G06Q 20/32

(52) U.S. Cl. CPC G06Q 20/3572; G06Q 20/32; G06Q 20/20; G06Q 20/1085

(57) ABSTRACT

A method of managing one or more identities in a transaction infrastructure uses a token identity. The user receives a physical token with a token identity known to a transaction authoriser. The user associates one or more transaction identities with the token identity. Before performing a transaction, the user may select one of the transaction identities when there is more than one of them, and identifies the selected transaction identity to the transaction authoriser. The user uses the physical token to perform a transaction with transaction apparatus associated with a transaction acquirer, whereby the transaction acquirer identifies the token identity to the transaction authoriser. The transaction authoriser then determines the selected transaction identity from the token identity, and establishes the transaction between an identity issuer for the selected transaction identity and the transaction acquirer. Suitable apparatus is described. An identity management service adapted to operate as a transaction authoriser is also described, as is use of a token identity as described without need for a physical token in e-commerce transactions.

### CROSS-REFERENCE TO RELATED APPLICATION

This application is a U.S. National Stage filing under 35 U.S.C. §119, based on and claiming benefit of and priority to GB Patent Application No. 1402236.2 filed Feb. 10, 2014.

### FIELD OF INVENTION

This invention relates generally to management of identities in a transaction infrastructure. In particular embodiments, but not exclusively, this relates to use of a single payment card to access multiple accounts.

### BACKGROUND OF INVENTION

Payment cards such as credit cards, debit cards and prepaid cards are very widely used for all forms of financial transaction. The use of payment cards has evolved significantly with technological developments over recent years. Originally, transactions were on paper, using an imprint of a payment card (also here termed as a transaction card) and confirmed by a signature. This approach was largely replaced by use of a magnetic stripe of a transaction card swiped through a magnetic stripe reader on a point of sale (POS) terminal to perform a transaction. Transaction cards developed to contain an integrated circuit (“chip cards” or “smart cards”) communicate with a smart card reader in the POS terminal. Using this approach, a transaction is typically confirmed by a personal identification number (PIN) entered by the card user. Cards of this type typically operate under the EMV and ISO/IEC 7816 standards for interoperation of chip cards and associated apparatus (such as POS terminals and ATMs). Technology has further developed to provide payment cards which operate contactlessly—under EMV, these are covered under the ISO/IEC 14443 standard. Using such cards, the account number and other relevant information can be read automatically from the card by a POS terminal, generally using a short range wireless technology such as Radio Frequency Identification (RFID)—this approach is generally referred to as “contactless” or “proximity” payment. This is typically enabled by embedding of an RFID tag in a card body together with a suitable antenna to allow transmission and receipt of wireless signals—the transmissions may be powered by a radio frequency interrogation signal emitted by a proximity reader in the POS terminal. For an effective connection to be made, the payment card may need to be brought into very close proximity to the proximity reader—this has security benefits and prevents collisions if there are multiple enabled payment cards in the general vicinity of the proximity reader, as will typically be the case in a retail establishment for example. This may be achieved by tapping the antenna of the payment card against the proximity reader of the POS terminal.

An alternative to use of contactless cards is to use a computing device such as a mobile telephone as a proxy for a payment card. For example, mobile payment applications have been developed which allow a mobile cellular telephone handset (hereafter “mobile phone”) to act as a proxy for a payment card using Near Field Communication (NFC) technology standards, which are built in to the majority of current mobile phones. Such applications may run within a secure element within the mobile phone, such as the SIM or a protected secure element used for cryptographic processes. Using such applications, a user can conduct tapping based transactions with a proximity reader, as well as perform account management operations over an appropriate network interface (cellular, local wireless network) in an online banking interface with the user's account provider.

Use of a mobile phone application may allow a user to use alternative cards associated with different accounts, for example by providing multiple instances of the application for the different cards. With a conventional physical payment card, the user does not have this option—the user needs a different physical card for each account.

At present, it is possible to use a physical contact card in a much larger number of locations than a contactless card or a mobile phone application that acts as if the mobile phone were a contactless card. There is a large installed base of POS terminals for contact cards, and many banks do not routinely issue contactless cards to their customers. It would be desirable for a cardholder to be able to use his or her card with the flexibility that is available in use of mobile phone applications that act as if the mobile phone were a contactless card, even in environments where no such mobile phone application can be used.

### SUMMARY OF INVENTION

In a first aspect, the invention provides a method of managing one or more identities in a transaction infrastructure, the method comprising: a user receiving a physical token with a token identity known to a transaction authoriser; associating multiple transaction identities with the token identity; the user using the physical token to perform a transaction with transaction apparatus associated with a transaction acquirer, whereby the transaction acquirer identifies the token identity to the transaction authoriser; the transaction authoriser determining the selected transaction identity from the token identity, and establishing the transaction between an identity issuer for the selected transaction identity and the transaction acquirer.

In some embodiments, the physical token is a transaction card, such as a payment card. This approach provides the user with the possibility of using any of the user's payment cards wherever the transaction authoriser card can be used without the need to have the relevant payment card physically present for the transaction. However, other implementations of a physical token may be provided—these may be used when the specific form factor of a payment card is not needed (for example, if a contactless connection rather than a chip and PIN contact arrangement is used). An advantage of using such an alternative form factor is that it may be easily worn by a user (such as a watch, or a ring), or may be integrated with another item used by the user regularly (a key fob, or a music player or other wearable gadget)—this may improve the user experience and may also add to security. A further alternative is that the physical token could be embodied in a mobile communications device, such as a tablet or phone running a suitable application and equipped with a suitable NFC facility.

The token identity may in this case be a primary account number, preferably one which relates to a transaction authoriser account, and not to a bank account. Preferably, the one or more transaction identities each comprise a primary account number. Each transaction identity primary account number may relate to a transaction card account provided by a card issuing bank. The transaction identity may also comprise an expiry date and a card verification code.

The transaction apparatus may be a point of sale terminal or an automated teller machine. The transaction acquirer may then be an acquiring bank associated with the point of sale terminal.

The identity issuer may be a card issuing bank.

In some embodiments, it is the user that associates the one or more transaction identities with the token identity, although in other embodiments an issuing bank, or agent thereof may carry out the association. The user may use computing apparatus to associate multiple transaction identities with the token identity and to select one of the multiple transaction identities and communicating the selected transaction identity to the transaction authoriser. The computing apparatus may be a mobile telephone. The transaction authoriser may also notify the computing apparatus that the selected transaction identity has been used.

In a second aspect, the invention provides a method for a user to manage one or more identities in a transaction infrastructure by use of computing apparatus and a physical token with a token identity known to a transaction authoriser, the method comprising: the user associating multiple transaction identities with the token identity by use of the computing apparatus and identifying such associations from the computing apparatus to the transaction authoriser; the user using the physical token to perform a transaction with transaction apparatus associated with a transaction acquirer such that the transaction acquirer will identify the token identity to the transaction authoriser.

In embodiments, the physical token is a transaction card, such as a payment card. As discussed above, the physical token may take other form factors to provide different advantages.

The token identity may be a primary account number, and wherein the one or more transaction identities each comprise a primary account number. Each transaction identity primary account number may relate to a transaction card account provided by a card issuing bank. The transaction identity may also comprise an expiry date and a card verification code.

In some embodiments, the method includes multiple transaction identities, the user selecting one of the multiple transaction identities on the computing apparatus and communicating identification of the selected transaction identity to the transaction authoriser.

The computing apparatus may receive a notification from the transaction authoriser that the selected transaction identity has been used.

In a third aspect, the invention comprises computing apparatus comprising a memory and a programmed processor, wherein the programmed processor is adapted to perform steps of the method of the second aspect set out above.

In embodiments, said computing apparatus is a mobile telephone. This will be a particularly advantageous context for the user to employ the invention. It should however be noted that any device capable of communicating (even intermittently) with the transaction authoriser may be used for this purpose—this could be another mobile computing device (such as a laptop computer or a tablet) or a fixed computing device (such as a desktop computer) with the relevant computing apparatus steps taken when the computing apparatus is available (and so not generally at the time of a transaction).

In a fourth aspect, the invention provides a method of providing an identity management service in a transaction infrastructure, the identity management service comprising a computing system, the method comprising: receiving at the computing system, a user association of one or more transaction identities with a token identity associated with a physical token; receiving at the computing system a notification of use of the physical token to perform a transaction with transaction apparatus associated with a transaction acquirer, whereby the notification is received from the transaction acquirer; the computing system determining the selected transaction identity from the token identity, and establishing the transaction between an identity issuer for the selected transaction identity and the transaction acquirer.

In some embodiments, the association of one or more transaction identities with the token identity may be received from a computing apparatus of the user. In other embodiments, the association may be received from an identity issuer related to the transaction identity.

In embodiments where there are multiple transaction identities, the method may include receiving at the computing system, from a computing apparatus of the user, a selection of one of the transaction identities that is intended to be used in a future transaction.

In embodiments, the physical token is a transaction card, such as a payment card, but as discussed above, other physical tokens may also be used to provide different advantages. The token identity may be a primary account number, and this primary account number may relate to a transaction authoriser account, and not to a bank account. The transaction identity may also comprise an expiry date and a card verification code.

Preferably, the multiple transaction identities each comprise a primary account number. Each transaction identity primary account number may relate to a transaction card account provided by a card issuing bank.

The transaction apparatus may be a point of sale terminal or an automated teller machine and the transaction acquirer is an acquiring bank associated with the point of sale terminal or automated teller machine.

The identity issuer may be a card issuing bank.

The computing system may notify the computing apparatus that the selected transaction identity has been used.

In a fifth aspect, the invention provides a computing system comprising a memory and a programmed processor, wherein the programmed processor is adapted to perform steps of the method of the fourth aspect set out above.

In a sixth aspect, the invention provides a method of providing an identity management service in a transaction infrastructure, the identity management service comprising a computing system, the method comprising: receiving at the computing system, an association of one or more transaction identities with a user identity provided by the identity management service; receiving at the computing system a notification of use of the user identity to perform a transaction with a transaction acquirer, whereby the notification is received from the transaction acquirer; the computing system determining the selected transaction identity from the user identity, and establishing the transaction between an identity issuer for the selected transaction identity and the transaction acquirer.

IN an embodiment, the association of one or more of the transaction identities with the user identity is received from a computing apparatus of the user. Alternatively, the association may be received from an identity issuer.

The method may also include receiving at the computing system, from a computing apparatus of the user, a selection of one of the transaction identities. This may be particularly advantageous in the case where there are multiple transaction identities associated with a single token identity.

Preferably, the transaction is an e-commerce transaction. For an e-commerce transaction, there is no need for a physical token to be provided—it is simply sufficient for the user identity to be provided in the form of the same details as needed to be provided for a typical e-commerce or online transaction, but in this case these details are associated with a “virtual card” user identity rather than an actual transaction card and transaction account of a transaction identity. However, as for other aspects of the invention, the virtual card represents an actual transaction identity as chosen by the user, and the transaction is established by the identity issuer for the transaction identity and the transaction acquirer. As the transaction identity itself is not used by the user in the transaction itself, this provides added security to the user against malicious interception of transaction data by spurious merchant websites or the like.

The user identity may in this case comprise a primary account number, an expiry date and a card verification code.

### BRIEF DESCRIPTION OF FIGURES

Embodiments of the invention will now be described, by way of example, with reference to the accompanying Figures, of which:

FIG. 1 shows elements of a system suitable for carrying out embodiments of the invention;

FIG. 2 illustrates a process flow in accordance with one aspect of the invention;

FIG. 3 illustrates a process flow for an embodiment of the invention applicable to the payment card transaction system of FIG. 1;

FIGS. 4a to 4c illustrates schematically a transaction card, a mobile phone and an identity management service adapted for use in the process flow of FIG. 3;

FIGS. 5a to 5e illustrate a mobile phone display at different stages of the process flow of FIG. 3; and

FIG. 6 illustrates a process for a cardholder to register with a physical token provider, and for associating transaction cards with an application associated with the physical token for use in the process of FIG. 3.

### DESCRIPTION OF SPECIFIC EMBODIMENTS

Specific embodiments of the invention will be described below with reference to the Figures.

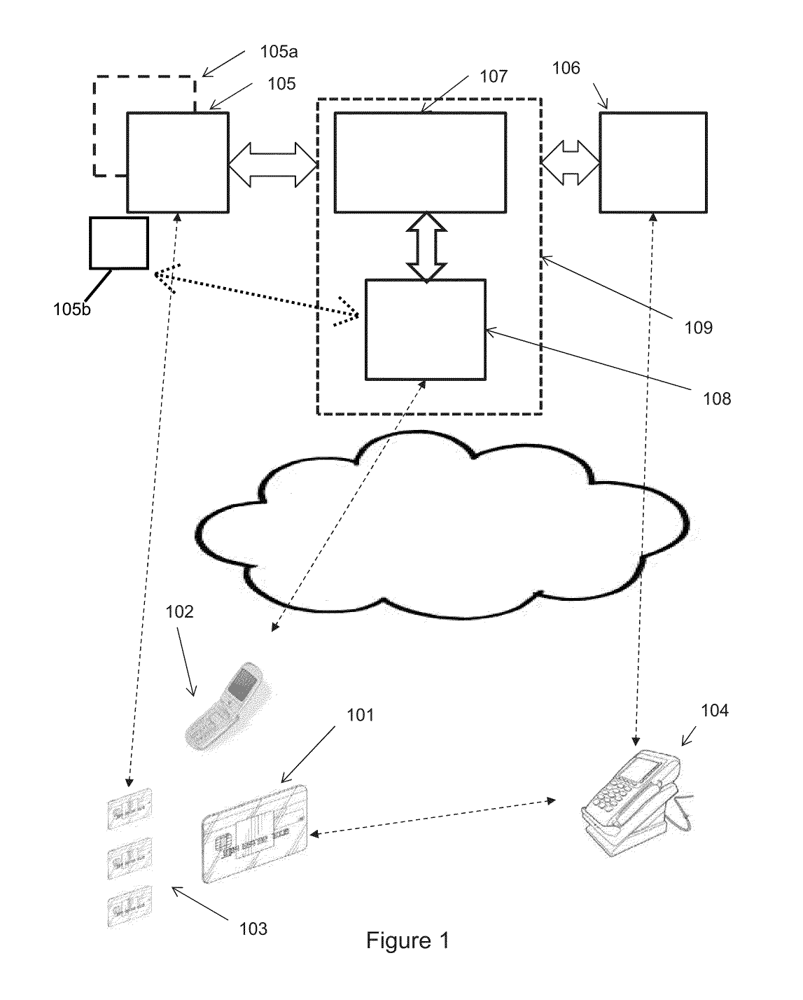

FIG. 1 shows schematically relevant parts of a representative transaction system suitable for implementing an embodiment of the invention. FIG. 1 illustrates use of the invention in the context of a payment card infrastructure, though as is discussed below, the invention has broader application and other embodiments of the invention relate to different technical contexts.

A user (not shown) is provided with a physical token with a token identity. In this case, the physical token is a payment device, specifically a payment card 101. As will be discussed further below, in other embodiments the physical token may have a different form factor from that of a payment card. The user also has a communication device—in this case a mobile phone 102, though as will be discussed below this need not be a cellular telecommunications device and may be any device capable of making a network connection to an identity management service 108. The mobile phone 102 comprises a means to manage multiple identities—in this case, the multiple identities represent multiple payment cards 103 owned or controlled by the user—although in some scenarios, as discussed later, the means may also be used to manage a single entity. This means may be a software application, as is discussed below.

In a transaction, the payment card 101 interacts with a transaction apparatus, such as POS (Point of Sale) terminal 104, associated with a merchant (not shown). The POS terminal 104 is associated with a transaction acquirer, in this case an acquiring bank 106. The multiple payment cards 103 are each associated with an “identity issuer” responsible for issuing an identity used by a user in a transaction, the identity issuer in this case being a card issuing bank 105, 105a. Note that a card issuing bank could also authorise a third party entity, shown here as 105b, to carry out the credential checking and identity issuing process on its behalf. Examples of such a third party entity could be an agent of the bank, a kiosk, an automated teller machine (ATM), or a mobile phone application that is under the control of the issuing bank. As such, the term ‘identity issuer’ and any equivalent terms used herein should be interpreted accordingly.

The user is thus a cardholder of the issuing bank—the terms “user” and “cardholder” will be used interchangeably in the description of transaction card embodiments. A transaction is established between a card issuing bank 105 and an acquiring bank 106 by a transaction authoriser such as payment network infrastructure 107 associated with a payment card, such as that provided by MasterCard. Transaction authorisation is only one service provided through the payment network infrastructure 107, which mediates not only transaction authorisation but also transaction clearance and settlement.

These elements of a transaction system are conventional—an additional element provided here is identity management service 108. As is indicated below, in embodiments some roles may be taken by either the payment network infrastructure 107 or the identity management service 108—these are thus shown together as part of an extended payment network infrastructure 109. As will be discussed below, when a transaction card 101 with a token identity of the type addressed by embodiments of the invention is used for a transaction, the identity management service 108 will be used to determine which card issuing bank should be involved in the transaction.

Embodiments of the invention may be employed with more than one transaction type. The main transaction type described below is an interaction with a conventional POS terminal. Embodiments for use with a conventional POS terminal will be usable in essentially the same way with a conventional ATM. Aspects of the invention may be used in other transaction types in which the customer is not physically collocated with the merchant (e-commerce transactions and telephone transactions—generally termed CNP (Customer Not Present) transactions). In these embodiments there will not be the same card-to-machine interaction, but a customer may still use a single “virtual” card to represent one of a number of card accounts. A benefit here is that the ability to stop the identity management account very quickly without compromising other use of the card accounts provides a valuable additional defence against card fraud.

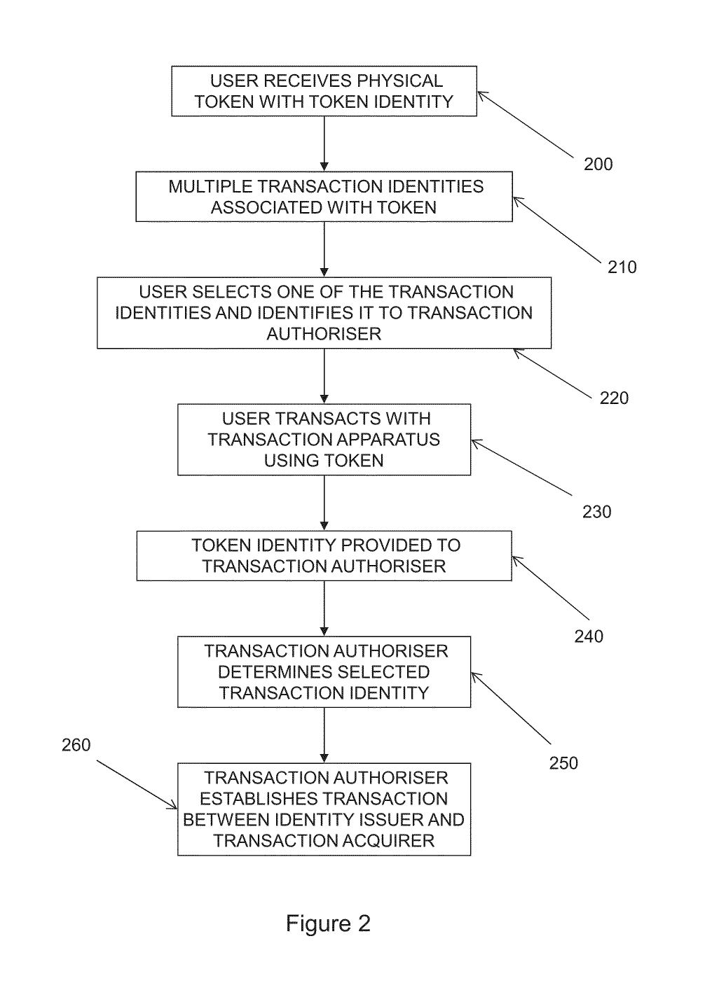

FIG. 2 illustrates a process flow in accordance with one aspect of the invention. In general terms, FIG. 2 shows steps in a method of managing identities in a transaction infrastructure. Although it is envisaged that the invention will be most useful in managing multiple identities, it is also considered to apply to the management of a single identity, as will become apparent in this description.

First of all, the user receives (200) a physical token. There is a token identity associated with this token (and generally one or more credentials associated with the identifier, and either stored on the physical token, recoverable through an infrastructure by using the token identity, or both). In embodiments described below, the physical token is a transaction card, and the token identity is a PAN (Primary Account Number) for the transaction card. The term “DPAN” or “Device PAN” will be used below to refer to the token PAN, with “FPAN” or “Funding PAN” used to refer to a bank account PAN. As discussed below this DPAN is not a conventional PAN—in that it does not relate to a bank account which can be credited or debited, but as far as the POS and the acquiring bank are concerned, the DPAN is equivalent to a conventional PAN (FPAN).

In the illustrated embodiment, the user associates (210) multiple transaction identities with the token. In the case of the transaction card discussed above, these may be FPANs of a number of conventional transaction cards (physical or even virtual). Typically this association will require a registration process in which enough information is provided, directly by the user or indirectly, to convince a transaction authoriser that the user is entitled to associate the conventional transaction card FPAN with the physical token identity.

In another scenario, it is envisaged that only one transaction identity may be associated with the physical token. The user may perform this association themselves, for example through a suitable software application, although other means to associate a transaction identify with a token identity are envisaged, as will become apparent. Such a scenario may be useful in developing countries which may have only a single issuing bank, but where it is still desirable to access the security and fraud prevention benefits of the invention, particularly where the physical token can be incorporated into something other than the form factor of a transaction card, for example integrated into a mobile phone, or perhaps integrated into an identity card (having a suitable computer processing chip and memory) that would be issued by a government institution. In the latter example, the government-issued ID card can also be provided with a functionality of a payment card, although fraud prevention is benefitted due to the existence of the token identity resident on the card that provides proxy-access to an actual user account. In such an example, following receipt of the ID card by the user, the user may then interact with an issuing bank, or an agent authorised by the bank, to associate a transaction identity with the token identity that is resident on the ID card. In this case, once the issuing bank has carried out suitable verifications, it creates an account for the user, which has a corresponding transaction identity, and contacts the identity management service 108 in order to associate the transaction identity with the token identity that is resident on the ID card.

Returning to the illustrated embodiment, before performing a transaction, the user selects (220) one of the multiple transaction identities and identifies (230) the selected transaction identity to the transaction authoriser. This may or may not be implemented so that the transaction identity itself is communicated to the transaction authoriser—the communication may comprise a reference or credential which allows the transaction identity to be retrieved by the transaction authoriser. At this point, the transaction authoriser establishes that the selected transaction identity is the active transaction identity corresponding to the token identity. Naturally, in the case of a single transaction entity, the selection step may be dispensed with since the transaction identity will be consistent between transactions. However, the user selection may conversely be retained if a user validation step is required prior to the transaction starting.

The user carries out a transaction (230) by using the physical token with transaction apparatus associated with a transaction acquirer—if the physical token is a transaction card, the transaction apparatus may be a merchant's POS terminal and the transaction acquirer may be the merchant's acquiring bank. The transaction acquirer receives the token identity (or sufficient information to allow the transaction authoriser to determine the token identity) as part of the transaction process and notifies (240) the transaction authoriser, so the token identity is provided to the transaction authoriser. Where the physical token is a transaction card and the token identity is a DPAN, this is achieved by a completely conventional provision of transaction details from the merchant POS to the merchant's acquiring bank, the acquiring bank then passing the transaction card PAN to the payment network infrastructure, which comprises (or is directly associated with) the transaction authoriser.

The transaction authoriser then determines (250) the selected transaction identity from the token identity—this will typically be the most recent transaction identity notified to the transaction authoriser. The transaction authoriser then establishes (250) the transaction between an identity issuer for the selected transaction identity and the transaction acquirer. In the case of a transaction card, this will typically involve the payment network infrastructure establishing a transaction between a card issuing bank with an account corresponding to the selected transaction identity and the merchant's acquiring bank.

In the above process, a registration procedure takes place in which the user is able to associate one or more transaction identities to a token identity. However, it will be appreciated that the same infrastructure may be used by the user to change the association of their transaction card identities with the token identity. For instance, this may be necessary in circumstances in which the user discontinues use of one of the transaction identities, for example if a credit card account is no longer needed on the expiry of a particular card account, or in the event that the card account is terminated by the issuer.

As has also been mentioned above, although it is envisaged that multiple transaction identities relating to a single token identity will be registered and managed efficiently by the user by way of a suitable software application, this is not essential.

In the above example where a government ID card may be issued with a single transaction identity associated with a single token identity, the user may interact with the issuing bank, or agent thereof, directly in order to revise or make changes to the transaction identity. This may be for example in circumstances where the user wishes to associate a new transaction entity from the same issuing bank with the token identity, which may be useful where the previous card relating to the registered transaction identity has been lost, or has expired. Alternatively, or in addition, the user may interact with another issuing bank in order to change the transaction identity on the physical token (ID card) to a different transaction identity associated with the new issuing bank. The issuing bank can therefore be responsible for authenticating the user and requesting that the identity management service 108 update the association between the transaction identity and the token identity.

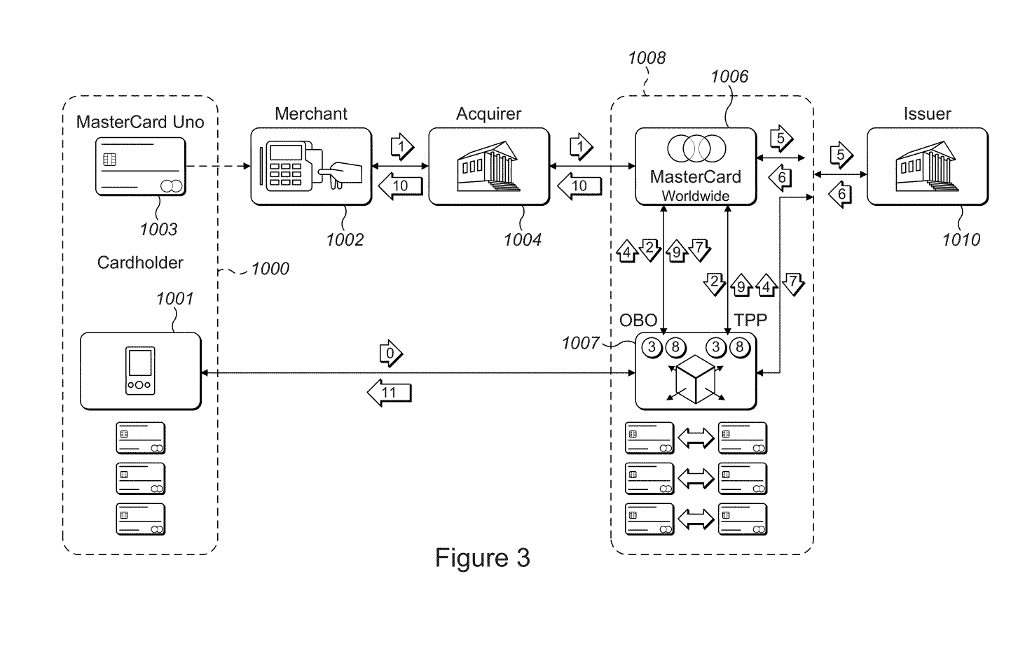

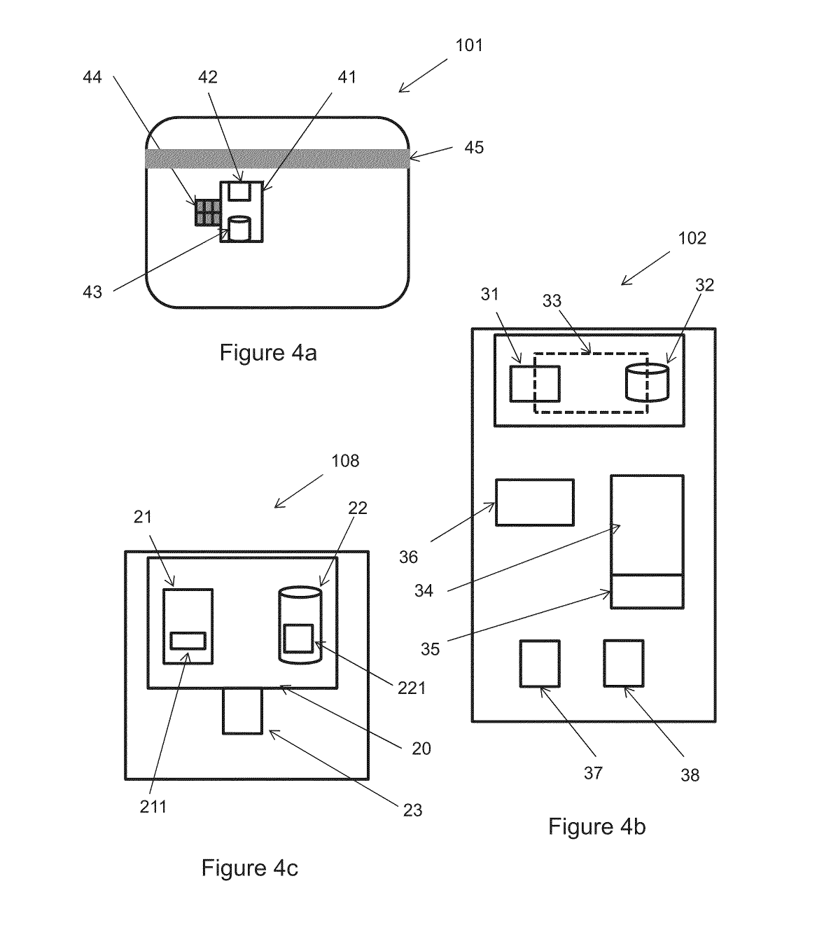

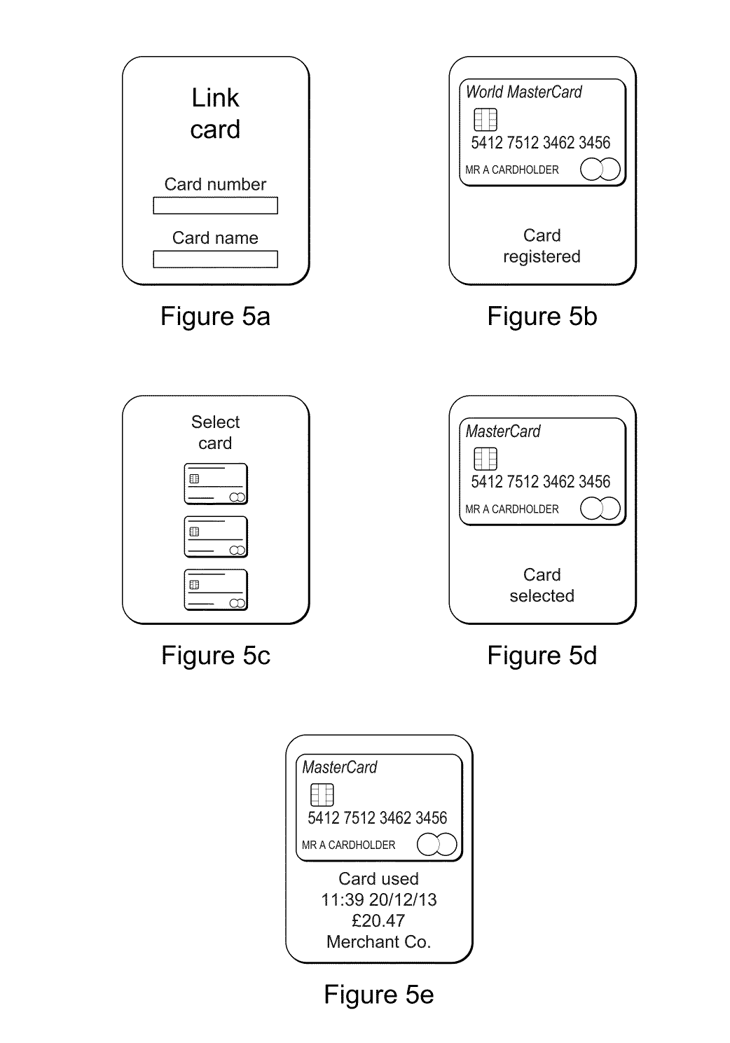

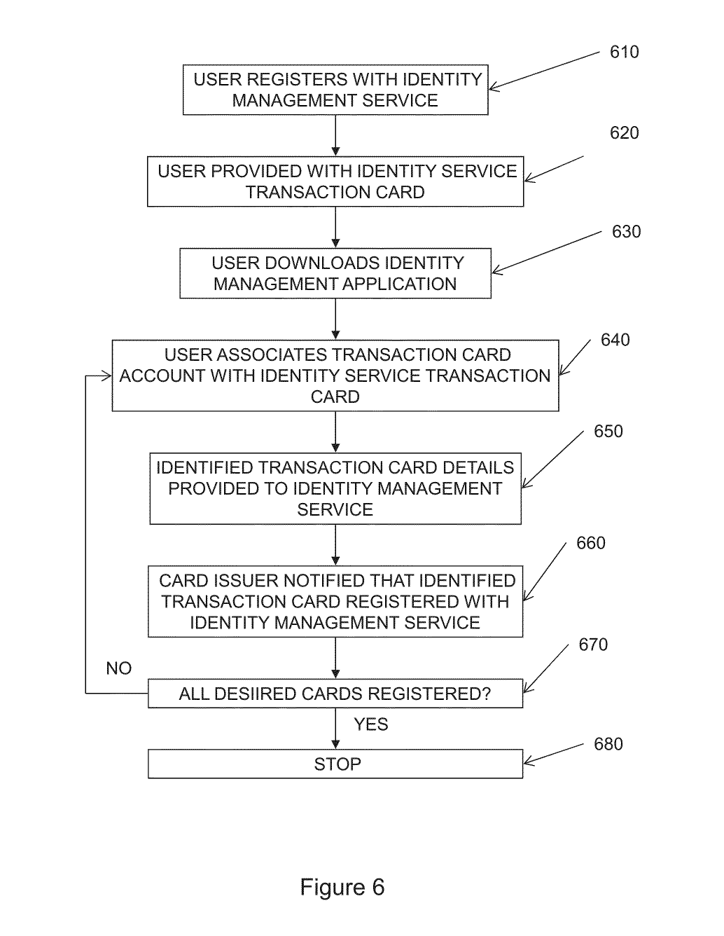

FIG. 3 illustrates in more detail a process flow for an embodiment of the invention applicable to the payment card transaction system of FIG. 1. The steps illustrated in FIG. 3 will be discussed with reference to the mobile phone and mobile phone application illustrated in FIGS. 4 and 5, and with reference to the registration process illustrated in FIG. 6. It is to be noted at this point that the scenario illustrated in these Figures relates to the management of multiple transaction identities in relation to a single token identity. However, it should be appreciated that other embodiments are envisaged that the token identity may be associated with a single transaction identity.

The elements of a transaction card and a mobile phone adapted for use in embodiments of the invention are shown in FIGS. 4a and 4b, and the elements of an identity management service 108 capable of acting as a transaction authoriser are shown in FIG. 4c. The transaction card 101 is, in terms of its physical structure, processing capability and applications, essentially identical to a conventional transaction card, capable of interacting with a POS terminal in accordance with the contact card standard ISO/IEC 7816 and EMV standards. The transaction card will typically have a chip 41 comprising a processor 42 and a memory 43 with contacts 44 for exchanging information with a POS terminal, and also a magnetic stripe 45 for providing account information where only a magnetic strip interface is available. Essentially the only necessary difference between the transaction card 101 and a conventional transaction card is in information carried—that the PAN of the transaction card 101 does not relate to a user's transaction card account with a card issuer, but rather to an account with an identity management service. It should be noted that the transaction card may have more, limited, or different, set of transaction card capabilities than shown here—for example, in embodiments the transaction card may have only a magnetic stripe and no chip, or it can also have contactless capability

While a mobile phone 102 is shown here, another portable computing apparatus such as a laptop, notebook or tablet computer, or even a fixed apparatus such as a desktop computer, can be used as computing apparatus in embodiments of the invention. The mobile phone comprises a processor 31 and a memory 32, such that the memory stores and the processor subsequently runs an identity management application 33. The mobile phone has a user interface comprising a display 34 and a touchscreen 35 (or other input device) and associated drivers to allow a user to enter data into and view information from the identity management application 33. The mobile phone 102 also has a cellular telecommunications capability, including subscriber information module 36 and wireless communication element 37 together providing the ability to connect to a cellular communications network. The mobile phone may need to perform cryptographic operations in order to interact securely with a POS terminal 104 or with the identity management service 108—this may be achieved by a cryptographic capability within the subscriber information module 36, such as a cryptographic processor in a tamperproof element. The mobile phone is here shown as having a local networking element 38 as well, in order to establish a short range wireless network connection—however, in other embodiments the mobile phone 30 may only be able to make network connections through a cellular telecommunications network. Where the computing device is not a mobile phone, then while a network connection is needed to enable communication between the computing device and the identity management service, this need not involve cellular telecommunications. For example, the computing device may be a tablet computer without cellular telecommunications capability but capable of making a local wireless network connection, and so a connection to the identity management service through the public internet. In some embodiments, the functionality of the physical token may be combined into the mobile phone.

An identity management service 108 capable of acting as a transaction authoriser is shown in FIG. 4c. This is shown as comprising a server 20 with processor 21 and memory 22, with associated communications functionality 23. The communications functionality may include networking capability allowing communication with the payment network infrastructure 107, optionally there may be a telecommunications capability allowing communication over a telecommunications network with the mobile phone 102, although such communication may be entirely over data networks in which case no telecommunications capability at the identity management service 108 would be required. The processor 21 is a representation of processing capability and may in practice be provided by several processors—cryptographic processor 211 is shown here as the element capable of providing cryptographic capability in establishing secure interaction with the mobile phone 102 or with the payment network infrastructure 107. The memory 22 comprises a database 221 for storing user account details, including a log of all transaction identities associated with an identity service transaction card and an indication of which transaction identity is currently active. As will be discussed further below, such an identity management service may be provided within a payment network infrastructure or as a separate service.

Before any transaction takes place, it is necessary for the transaction card to be issued and for transaction identities to be associated with the transaction, as has been described in the various scenarios mentioned above. A suitable registration process is shown in FIG. 6. First of all, a user must register 610 with the identity management service 108—as noted above, this service may be part of the payment network infrastructure, or may be a third party with an appropriate relationship with the payment network infrastructure with a sufficient degree of trust between them. The identity management service provides the user 620 with an identity service transaction card with the form factor of a conventional credit card—in particular, the transaction card will be able to interact with a conventional POS terminal by contact protocols (such as direct contact for a chip card or by magnetic stripe) or contactless protocols if desired and appropriate. The identity service transaction card is capable of interacting with a POS terminal in exactly the same way as a conventional transaction card associated with the payment network infrastructure. As far as a merchant and a merchant's acquiring bank are concerned, the identity service transaction card is a completely conventional transaction card. The identity service transaction card may or may not have its own PIN—different implementations of a PIN are discussed below. The user (cardholder) also downloads 630 an identity management application to his or her mobile phone or other computing device to allow management of multiple transaction identities. There may be one or more transaction identities already associated with the identity service transaction card—for example, if the use of the identity management service 108 is a service offered by a cardholder bank for one of the user's transaction cards—or it may be necessary for the user to associate any transaction identities himself or herself.

If the user wishes to use the transaction card for multiple transaction identities, the user needs to associate multiple 640 transaction identities, each being in the form of transaction card details allowing access to a transaction card account with a card issuing bank. FIG. 5a shows an exemplary interface to the identity management application on the mobile phone with a series of fields for the user to enter transaction card details. These should, on communication to the identity management service 108, provide sufficient detail for the identity management service to be satisfied 650 that the transaction card to be entered is under the control of the user of the computing device and that the identified transaction card should be added as a possible identity for the identity service transaction card. Much of this information will be at least sensitive to the user, and communications between the mobile phone and the identity management service should be secure. It should however be noted that authorisation of a transaction will still require the involvement of the card issuing bank when this would normally be required by the transaction process (or by the payment network infrastructure). Optionally, there may also at this point be a process by which the card issuer for the identified transaction card is notified 660 that the identified transaction card has been registered with the identity management service (another possibility is that the card issuer's approval is required). The identity management service 108 will confirm (see FIG. 5b) that the transaction card has been registered. These steps can be repeated until all the user's transaction cards, or a chosen subset of them, are entered through the identity management application and registered with the identity management service.

As has been mentioned above, in an alternative scenario, it is possible for the user to carry out the registration process by way of direct interaction with the issuing bank, or an agent thereof. In this way, once the issuing bank has verified the user's credentials, it is able to contact the identity management service 108 in order to register a transaction identity of a user's transaction card account with the token identity.

Once the registration of the one or more transaction identities has been completed, step 0 of FIG. 3 may now take place—this involves the selection of a transaction card by the user 1000 through the identity management application 1001 on the mobile phone. This may take place any time before a transaction—while it may take place immediately before a transaction, it may also be determined quite separately from any transaction. As noted above, in circumstances where there is only a single transaction identity associated with the physical token, in whatever form, the selection step may not be necessary. FIG. 5c shows an exemplary interface for the mobile phone identity management application for transaction card selection. On selection of a transaction card to use, the identity management application 1001 contacts the identity management service 1007 over whatever network connection is available to establish that the selected transaction card is the active transaction card for the identity service transaction card. This is confirmed by a message from the identity management service (FIG. 5d).

The interaction between the mobile phone application 1001 and the identity management service 1007 needs to exchange sufficient information to assure each party that they are communicating with the other party—it may also be desirable to protect the application on the mobile phone by a credential known to the user so that it is only accessible by the legitimate user, and not a casual user of the mobile phone. However, when this has been done, additional security steps may not be needed for active transaction card selection, as credentials have already been shared with the identity management service 1007 as needed as part of the registration process.

The simplest implementation of the choice of active transaction card is simply that the last card selected is the active transaction card. Here, therefore, the selection is implicit in that the active transaction card is selected by default. Other arrangements are possible, however. For example, the user may establish a default card, and may establish that an alternative card be used for a selected period of time (for example, for the duration of a foreign trip where an alternative card billed in a different currency would be a better choice), with the active transaction card reverting to the default choice thereafter. Other rules and schemes could be used. For example, the user may be able to set rules based on (i) transaction type (POS, ATM, CNP), (ii) time of transaction, (iii) location of transaction, (iv) value of transaction, or other parameters. In another embodiment, in which a single transaction identity is associated with the physical token identity, the selection step is implicit since the selection is made by default as there is only one identity. As shown at Step 1, the transaction is initiated as a normal card transaction. The cardholder 1000 presents the identity service transaction card to a merchant POS or just ‘merchant’ 1002 and enters an appropriate PIN when required. The merchant 1002 then passes transaction details to the merchant's acquiring bank 1004 for authorisation, and the acquiring bank 1004 in turn passes the transaction details to a master switch 1006 of a payment network infrastructure 1008 to obtain authorisation from a cardholder bank 1010.

In order for the cardholder 1000 to demonstrate his or her right to use a transaction card, it will typically be necessary for the cardholder to enter a PIN when entering into a transaction with a POS terminal or an ATM. In embodiments of the invention, this can be implemented in more than one way. In one arrangement, when prompted for a PIN, the cardholder enters the PIN of the currently active transaction card (an FPAN PIN). In this implementation, the PIN is transmitted to the card issuing bank for verification of the PIN once the card issuing bank has been identified by the identity management service. The card issuing bank then provides verification of the PIN to authenticate the cardholder for the transaction.

In an alternative implementation of a PIN, the identity service transaction card 1003 has its own PIN (DPAN PIN), and this is entered by the cardholder when prompted for a PIN. In this case, the DPAN PIN is provided to the identity management service, along with other DPAN information. While the DPAN itself is used to determine the FPAN, the DPAN PIN is verified by the identity management service to authenticate that the cardholder is the legitimate cardholder of the identity service transaction card. The identity management service 1007 will then advise the card issuing bank 1010 (directly or indirectly through the payment network infrastructure 1008) by a message, or one or more specific fields in an existing message, that the cardholder is trusted by the identity management service and hence by the payment network infrastructure. As there is an appropriate trust relationship between the payment network infrastructure or the identity management service and the card issuing bank, the card issuing bank will accept that the cardholder is trusted from this message without requiring the production of the FPAN PIN.

At Step 2, the payment network infrastructure 1008 determines from the DPAN that the DPAN relates not to a cardholder bank account, but to an identity service account (the identity management service 1007 is also designated OBO in FIG. 3 where the service is essentially a part of the payment network infrastructure 1008, and TPP where this is a third party service). This in itself requires no major change—a PAN is already used to route transaction information to individual banks, so the use of the DPAN to route a transaction to the identity management service involves only an addition to an existing routing table. The transaction details are then either routed to the identity management service 1007, or the identity management service is simply called by the payment network infrastructure 1008 to identify the currently active customer FPAN for the identity service transaction card 1003.

At Step 3, the identity management service 1007 determines the currently active customer FPAN—this will typically just be by database lookup, using suitable parameters to enable the selected transaction identity to be used in the transaction. If a DPAN PIN is used, the identity management service 1007 may at this point also need to provide assurance that the identity service transaction card 1003 has been used by a legitimate user. Transaction information may also need to be prepared by the identity management service 1007 so that transaction information is in the form expected by the cardholder bank 1010 for the active customer account.

At Step 4 the identity management service 1007 returns the active customer account FPAN to the master switch 1006 of the payment network infrastructure 1008 (in the case of a third party service TPP, this may instead be a communication directly to the card issuer), together with any additional information needed to construct an authorization request to the card issuing bank 1010. This may take the form of a fully formulated authorisation request if the transaction details have been forwarded to the identity management service 1007, or may only provide the information necessary to allow the master switch 1006 to formulate this authorization request. At Step 5, the authorisation request is sent to the card issuing bank 1010 for the active transaction card account. This may be provided in the same way as an authorisation request resulting from an existing type of credit card transaction (such as a direct interaction between the physical transaction card for the active transaction card account and a POS terminal, or a CNP transaction using the active transaction card account), but will preferably be augmented by an indication that PAN translation (from DPAN to FPAN) was carried out. Such information may be used by the card issuing bank 1010 in risk management processes, for example.

At Step 6, the card issuing bank 1010 sends an authorisation response back to the master switch 1006 as for a conventional transaction. At Step 7, the master switch 1006 (or in the case of a third party identity management service, the card issuer) reverts to the identity management service 1007 to provide notification and (if this has not been stored at the master switch) to obtain a mapping from the FPAN of the active transaction card account back to the DPAN. It should be noted that the master switch 1006 will need—either from information in the authorisation response or information that can be obtained using the authorisation response—to identify the authorisation response as relating to a transaction made using the identity service transaction card 1003. This is because as far as the merchant 1002 and the merchant's acquiring bank 1004 are concerned, the expected authorisation relates to the identity service transaction card 1003 and not the active transaction card account. In preferred embodiments, it will still be possible for a user to use the transaction card account directly—the identity service transaction card provides an alternative, rather than a replacement, to conventional use of the active transaction card.

At Step 8, the identity management service 1007 performs the necessary reverse mapping as needed, but also notes whether or not the transaction has been authorised for subsequent communication with the user. At Step 9, the master switch 1006 receives (if necessary) the DPAN and any other information needed to construct an appropriate authorisation response to the merchant's acquiring bank 1004 for the identity service transaction card 1003. At Step 10, the authorisation response is sent to the merchant's acquiring bank 1004, and then sent to the merchant to confirm to the merchant that the transaction is authorised in the conventional manner.

In addition to this conventional authorisation response, the identity management service 1007 may also at Step 11 provide a notification to the user that the identity management service has authorised a transaction using the identity service transaction card 1003—a useful user confirmation may also contain an identification of the active transaction card account used, together with sufficient detail of the transaction to allow the user to identify it. An exemplary notification is shown in FIG. 5e. This provides a valuable additional check to the user to ensure that the correct card is being used.

The approach set out above allows a user to use only one physical card—the identity service transaction card—in general use, while keeping his or her other cards securely. If the user loses his or her wallet or bag, only one physical card will be lost, and this card can be deactivated by a single communication to the identity management service.

If, as preferred, transaction cards registered with the identity management service can still be used independently, this reduces the inconvenience of physical card loss to the user—if the identity service transaction card is lost or stolen, the user simply stops this card and reverts to using individual transaction cards as before. This benefit applies as much to CNP transactions (where the perceived risk of fraud may be greater) as to POS and

ATM transactions, so aspects of the invention in which the DPAN together with appropriate user credentials are used in e-commerce or other CNP transactions provide an important customer benefit in that a compromised DPAN can be stopped without preventing use of any FPAN.

In the embodiments described above, the physical token has the form factor of a transaction card. In other embodiments, this need not be the case. Other implementations of a physical token may be provided—these may be used when the specific form factor of a payment card is not needed (for example, if a contactless connection rather than a chip and PIN contact arrangement is used). An advantage of using such an alternative form factor is that it may be easily worn by a user (such as a watch, or a ring), or may be integrated with another item used by the user regularly (a key fob, or a music player or other wearable gadget). Indeed, the physical token may be integrated into the user's mobile phone when equipped with suitable NFC communications apparatus. The user may find it easier to integrate such a physical token into their life, as it may be an object that they would normally keep with them at all times. This may improve the user experience. It may also add to security, as the object may be more securely held by the user than a payment card would be (if, for example, it was worn on the body) and it may also not appear to be a payment card or a payment card proxy to a thief.

As indicated above, in the case of e-commerce and other CNP transactions, this approach can still be used with considerable benefit, including to provide additional protection against card fraud. In the case of use for CNP transactions alone there need not be a physical token held by the user—card details may be that of a “virtual card”. The card details entered on an e-commerce site by the cardholder of the virtual card will be the same details as are printed on a DPAN transaction card (16-digit PAN, Expiry Date and the 3-digit CVC2) for physical token embodiments. The identity service operates in exactly the same way as before to establish the transaction between the card issuing bank and the acquiring bank—there will be no PIN considerations arising as a PIN is not used for such CNP transactions. Where there is a physical token, this e-commerce approach can of course also be used—the cardholder can enter details from the physical token on to a page served by a merchant website exactly as for a conventional e-commerce transaction. While the embodiment described above is particularly relevant to a payment network using transaction cards, other uses unrelated to payment transactions are possible. One such use is to provide a single identity card which can be used for admission to different facilities which have different authorisation systems, rather than by using a separate identity card for each system. Such a generic identity card may be provided, for example, to agency workers by their employment agency as their identity card. The generic identity card is read by a reader in the local facility, which then reverts back to an authorisation infrastructure which interprets the card as being a generic identity card rather than a specific guarantor's identity card. An identity management service holds a record of the currently active guarantor for the card—this may be the guarantor relevant to a particular facility. In this way only the necessary identity details need to be recorded with the relevant guarantor, without the need to issue a new physical card—for a short term appointment, it may be practical to do the former but not the latter.

As the person skilled in the art will appreciate, modifications and variations to the above embodiments may be provided, and further embodiments may be developed, without departing from the spirit and scope of the invention. Reference to standards and proprietary technologies are provided for the purpose of describing effective implementations, and do not limit the scope of the invention.

1. A method of managing one or more identities in a transaction infrastructure, the method comprising:
a user receiving a physical token with a token identity known to a transaction authoriser;
associating one or more transaction identities with the token identity;
the user using the physical token to perform a transaction with transaction apparatus associated with a transaction acquirer, whereby the transaction acquirer identifies the token identity to the transaction authoriser;
the transaction authoriser determining the selected transaction identity from the token identity, and establishing the transaction between an identity issuer for the selected transaction identity and the transaction acquirer.

2. A method as claimed in claim 1, wherein the physical token is a transaction card.

3. A method as claimed in claim 2, wherein the transaction card is a payment card.

4. A method as claimed in claim 1, wherein the token identity is a primary account number.

5. A method as claimed in claim 4, wherein the primary account number relates to a transaction authoriser account, and not to a bank account.

6. A method as claimed in claim 1, wherein the one or more transaction identities each comprise a primary account number.

7. A method as claimed in claim 6, wherein each transaction identity primary account number relates to a transaction card account provided by a card issuing bank.

8. A method as claimed in claim 1, wherein the transaction apparatus is a point of sale terminal or automated teller machine.

9. A method as claimed in claim 8, wherein the transaction acquirer is an acquiring bank associated with the point of sale terminal or automated teller machine.

10. A method as claimed in claim 1, wherein the identity issuer is a card issuing bank.

11. A method as claimed in claim 1, wherein the user associates one or more transaction identities with the token identity.

12. A method as claimed in claim 1, wherein an identity issuer associates one or more transaction identities with the token identity

13. A method as claimed in claim 1, including multiple transaction identity associated with the token identity.

14. A method as claimed in claim 13, wherein the user selects one of the multiple transaction identities and identifies the selected transaction identity to the transaction authoriser.

15. A method as claimed in claim 11, wherein the user uses computing apparatus to associate multiple transaction identities with the token identity, and to select one of the multiple transaction identities and identify the selected transaction identity to the transaction authoriser.

16. A method as claimed in claim 15, wherein the computing apparatus is a mobile telephone.

17. A method as claimed in claim 15, further comprising the transaction authoriser notifying the computing apparatus that the selected transaction identity has been used.

18. A method for a user to manage one or more identities in a transaction infrastructure by use of computing apparatus and a physical token with a token identity known to a transaction authoriser, the method comprising:
the user associating one or more transaction identities with the token identity by use of the computing apparatus and communicating such associations from the computing apparatus to the transaction authoriser;
the user using the physical token to perform a transaction with transaction apparatus associated with a transaction acquirer such that the transaction acquirer will identify the token identity to the transaction authoriser.

19. A method as claimed in claim 18, wherein the physical token is a transaction card.

20. A method as claimed in claim 19, wherein the transaction card is a payment card.

21. A method as claimed in claim 18, wherein the token identity is a primary account number, and wherein the one or more transaction identities each comprise a primary account number.

22. A method as claimed in claim 21, wherein each transaction identity primary account number relates to a transaction card account provided by a card issuing bank.

23. A method as claimed in claim 18, including multiple transaction identities, the user selecting one of the multiple transaction identities on the computing apparatus and communicating identification of the selected transaction identity to the transaction authoriser.

24. A method as claimed in claim 23, further comprising the computing apparatus receiving a notification from the transaction authoriser that the selected transaction identity has been used.

25. An apparatus, comprising:
a memory and a programmed processor, wherein the programmed processor is adapted to perform steps to:
allow a user to associate one or more transaction identities with a token identity associated with a physical token by use of the apparatus and communicating such associations from the apparatus to a transaction authoriser; and
allow a user to use the physical token to perform a transaction with transaction apparatus associated with a transaction acquirer such that the transaction acquirer will identify the token identity to the transaction authoriser.

26. The apparatus as claimed in claim 25, wherein said apparatus is a mobile telephone.

27. A method of providing an identity management service in a transaction infrastructure, the identity management service comprising a computing system, the method comprising:
receiving at the computing system an association of one or more transaction identities with a token identity associated with a physical token;
receiving at the computing system a notification of use of the physical token to perform a transaction with transaction apparatus associated with a transaction acquirer, whereby the notification is received from the transaction acquirer;
the computing system determining the selected transaction identity from the token identity, and establishing the transaction between an identity issuer for the selected transaction identity and the transaction acquirer.

28. A method as claimed in claim 27, wherein the association of one or more transaction identities with the token identity is received from a computing apparatus of the user.

29. A method as claimed in claim 27, wherein the association of one or more transaction identities from the token identity is received from a computing apparatus of an identity issuer.

30. A method as claimed in claim 27, including receiving at the computing system, from a computing apparatus of the user, a selection of one of the transaction identities.

31. A method as claimed in claim 27, wherein the physical token is a transaction card.

32. A method as claimed in claim 31, wherein the transaction card is a payment card.

33. A method as claimed in claims 27, wherein the token identity is a primary account number.

34. A method as claimed in claim 33, wherein the primary account number relates to a transaction authoriser account, and not to a bank account.

35. A method as claimed in claim 27, wherein each transaction identity comprises a primary account number.

36. A method as claimed in claim 35, wherein each transaction identity primary account number relates to a transaction card account provided by a card issuing bank.

37. A method as claimed in claim 27, wherein the transaction apparatus is a point of sale terminal or an automated teller machine and the transaction acquirer is an acquiring bank associated with the point of sale terminal or automated teller machine.

38. A method as claimed in claim 27, wherein the identity issuer is a card issuing bank.

39. A method as claimed in claim 31, including receiving at the computing system, from a computing apparatus of the user, a selection of one of the transaction identities, and further comprising the computing system notifying the computing apparatus that the selected transaction identity has been used.

40. A computing system comprising:
a memory and a programmed processor, wherein the programmed processor is adapted to perform steps including
receiving at the computing system an association of one or more transaction identities with a token identity associated with a physical token;
receiving at the computing system a notification of use of the physical token to perform a transaction with transaction apparatus associated with a transaction acquirer, whereby the notification is received from the transaction acquirer; and
operating the computing system to determine the selected transaction identity from the token identity, and establishing the transaction between an identity issuer for the selected transaction identity and the transaction acquirer.

41. A method of providing an identity management service in a transaction infrastructure, the identity management service comprising a computing system, the method comprising:
receiving at the computing system, an association of one or more transaction identities with a user identity provided by the identity management service;
receiving at the computing system a notification of use of the user identity to perform a transaction with a transaction acquirer, whereby the notification is received from the transaction acquirer;
the computing system determining the selected transaction identity from the user identity, and establishing the transaction between an identity issuer for the selected transaction identity and the transaction acquirer.

42. A method as claimed in claim 41, wherein the association of one or more transaction identities with the user identity is received from a computing apparatus of the user.

43. A method as claimed in claim 41, wherein the association of one or more transaction identities with the user identity is received from a computing apparatus of an identity issuer.

44. A method as claimed in claim 41, including receiving at the computing system, from a computing apparatus of the user, a selection of one of the transaction identities.

45. A method as claimed in claim 41, wherein the transaction is an e-commerce transaction.

46. A method as claimed in claim 45, wherein the user identity comprises a primary account number, an expiry date and a card verification code.
